(19) United States
(12) Patent Application Publication
(10) Pub. No.: US 2015/0355017 A1
(43) Pub. Date: Dec. 10, 2015

(54) METHODS AND SYSTEMS FOR CALIBRATING IRRADIANCE SENSORS

(71) Applicant: SunEdison Inc., St. Peters, MO (US)

(72) Inventors: Christopher Andrew Clarke, Greenwood Village, CO (US); Stephen James Voss, Louisville, CO (US); Alemu Tadesse, Denver, CO (US); Anastasios Golnas, Annapolis, MD (US); Joseph Philip, Washington, DC (US); Joseph Michael Bryan, San Francisco, CA (US)

(21) Appl. No.: 14/297,348

(22) Filed: Jun. 5, 2014

(51) Int. Cl. G01J 1/42; G01J 1/02

(52) U.S. Cl. CPC G01J 1/42; G01J 1/02

(57) ABSTRACT

A method for calibrating irradiance sensors is performed by an irradiance analysis computing device in communication with a memory. The method includes receiving an irradiance estimate representing an expected amount of irradiance, receiving a first irradiance value associated with at least one irradiance sensor, processing the irradiance estimate and the first irradiance value to generate at least one irradiance metric, and determining a condition of said irradiance sensor based at least in part on the at least one irradiance metric.

### FIELD

The field of the disclosure relates generally to irradiance sensors. More particularly, this disclosure relates to methods and systems for calibrating irradiance sensors using irradiance profiles for a given location and photovoltaic system orientation.

### BACKGROUND

In photovoltaic (PV) systems, incident irradiance on the PV modules has a significant impact on the performance of the PV systems. Accurate measurement of irradiance associated with a PV system is therefore important to determining system performance. Increasing the accuracy and confidence level in measured irradiance leads to a more accurate assessment of system performance. Irradiance levels are typically measured using irradiance sensors such as pyranometers or reference cells.

The accuracy of irradiance sensors may be negatively affected or distorted by many factors. Further, in at least some PV systems, irradiance sensors may be difficult to inspect and validate. In some cases, access to irradiance sensors is limited. In other cases, redundant irradiance sensors cannot be used to validate or verify other irradiance sensors. In further cases, irradiance sensors may be too numerous or remote for efficient inspection.

When irradiance sensors measure irradiance inaccurately, the accuracy of system performance data similarly may be inaccurate. Such inaccuracy can lead to imprecise reporting, training methods, and maintenance procedures for the PV system. Accordingly, improved systems and methods for calibrating irradiance sensors are needed. Such tools may additionally be used to provide performance diagnostics for irradiance sensors including determination of drift and degradation and determining a characterization of the irradiance sensors.

This Background section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### BRIEF SUMMARY

In one aspect, a method for calibrating irradiance sensors is performed by an irradiance analysis computing device in communication with a memory. The method includes receiving an irradiance estimate representing an expected amount of irradiance, receiving a first irradiance value associated with at least one irradiance sensor, processing the irradiance estimate and the first irradiance value to generate at least one irradiance metric, and determining the condition of the at least one irradiance sensor based at least in part on the at least one irradiance metric.

In another aspect, an irradiance analysis computing device for calibrating irradiance sensors includes a processor and a memory coupled to the processor. The irradiance analysis computing device is configured to receive an irradiance estimate representing an expected amount of irradiance, receive a first irradiance value associated with at least one irradiance sensor, process the irradiance estimate and the first irradiance value to generate at least one irradiance metric, and determine a condition of the at least one irradiance sensor based at least in part on the at least one irradiance metric.

Another aspect of the present disclosure is a computer-readable storage media for calibrating irradiance sensors, the computer-readable storage media having non-transitory, computer-executable instructions embodied thereon. When executed by a irradiance analysis computing device comprising a processor and a memory coupled to the processor, the computer-executable instructions cause the irradiance analysis computing device to receive an irradiance estimate representing an expected amount of irradiance, receive a first irradiance value associated with at least one irradiance sensor, process the irradiance estimate and the first irradiance value to generate at least one irradiance metric, and determine a condition of the at least one irradiance sensor based at least in part on the at least one irradiance metric.

A further aspect of the present disclosure is an irradiance analysis system used to calibrate an irradiance sensor associated with a photovoltaic system (“PV system”) comprising a PV system, an irradiance sensor associated with the PV system configured to determine irradiance measurements of the PV system, and an irradiance analysis computing device in networked communication with the irradiance sensor. The irradiance analysis computing device includes a processor and a memory coupled to the processor. The processor is configured to receive an irradiance estimate representing an expected amount of irradiance received by the PV system, receive a first irradiance value from the irradiance sensor, the process the irradiance estimate and the first irradiance value to generate at least one irradiance metric, and determine a condition of the irradiance sensor based at least in part on the at least one irradiance metric.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated embodiments may be incorporated into any of the above-described aspects, alone or in any combination.

### BRIEF DESCRIPTION OF THE DRAWINGS

FIG. 1 is a perspective view of an example photovoltaic (PV) module;

FIG. 2 is a cross-sectional view of the PV module shown in FIG. 1 taken along the line A-A;

FIG. 3 is a lateral view of an irradiance sensor used to measure irradiance in the same location as the PV module shown in FIGS. 1 and 2;

FIG. 4 is a block diagram of an example computing device;

FIG. 5 is a block diagram of an example PV system;

FIG. 6 is a flow diagram of an example method of determining irradiance profiles for irradiance sensors;

FIG. 7 is a flow diagram of an additional example method of determining irradiance profiles for irradiance sensors;

FIG. 8 is a diagram of components of example computing devices such as the computing device of FIG. 4; and

FIGS. 9-12 are charts showing irradiance estimates and first irradiance values over a period of time.

Like reference symbols in the various drawings indicate like elements.

### DETAILED DESCRIPTION

Computer systems, such as irradiance analysis computing devices, may include a processor and a memory. However, any processor in a computer device referred to herein may also refer to one or more processors wherein the processor may be in one computing device or a plurality of computing devices acting in parallel. Additionally, any memory in a computer device referred to may also refer to one or more memories, wherein the memories may be in one computing device or a plurality of computing devices acting in parallel.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.” The term “database” may refer to either a body of data, a relational database management system (RDBMS), or to both. A database may include any collection of data including hierarchical databases, relational databases, flat file databases, object-relational databases, object oriented databases, and any other structured collection of records or data that is stored in a computer system. The above are only examples, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

In one embodiment, a computer program is provided, and the program is embodied on a computer readable medium. In an example embodiment, the system is executed on a single computer system, without requiring a connection to a server computer. In a further embodiment, the system is run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

The embodiments described generally relate to irradiance sensors. More particularly, the embodiments described relate to methods and systems for predicting irradiance profiles for a given location and photovoltaic system orientation, and to systems and methods for calibrating irradiance sensors using irradiance profiles. More specifically, systems and methods of some embodiments facilitate the identification of a status of an irradiance sensor as being in a normal state or an anomalous state. The systems and methods described herein include (i) receiving an irradiance estimate representing an expected amount of irradiance, (ii) receiving a first irradiance value associated with at least one irradiance sensor, (iii) processing, at the irradiance analysis computing device, the irradiance estimate and the first irradiance value to generate at least one irradiance metric, and (iv) determining whether the at least one irradiance sensor is in a normal condition or an anomalous condition based at least in part on the at least one irradiance metric.

In many known examples, photovoltaic (“PV”) systems, irradiance measurements are taken to determine broadband solar irradiance associated with portions of the PV system. Such irradiance measurements are taken using irradiance sensors. In the example embodiment, irradiance sensors include pyranometers. The pyranometers may be of a thermopile type or a photodiode type. In the example embodiment, the pyranometer is a thermopile type pyranometer. In alternative embodiments, the irradiance sensor may be another irradiance measuring device such as a reference cell. Irradiance measurements are used to facilitate estimations of PV system performance.

Accordingly, for suitable performance of PV systems, it is important that irradiance sensors accurately measure irradiance. However, the measurement accuracy of irradiance sensors may be affected or distorted by many factors. For example, irradiance measurement accuracy may be impacted by irradiance sensors that have gone out of calibration or proper orientation. Alternately, measurement accuracy may be impacted when an irradiance sensor is obstructed or impaired. Further, some irradiance sensors are contaminated by materials accumulating on the surface of the sensor.

Such inaccuracy in irradiance measurements is further associated with imprecise reporting, training methods, and maintenance procedures for the PV system. Further, such inaccuracy can result in a reduction of PV system energy production due to, for example, not remediating soiling or miscalibration in a timely manner. Inaccuracy of irradiance measurement may further translate to loss of time by analysts and field technicians and loss of capital due to production losses. As used herein, soiling refers to any accumulation of contaminants or foreign materials on PV systems and irradiance sensors that may result in reductions of output or inaccurate measurements.

The irradiance analysis computing device utilizes a baseline of irradiance in order to facilitate calibration. In the example embodiment, the irradiance analysis computing device receives an irradiance estimate representing an expected amount measurement of irradiance during a particular period of time. The irradiance estimate is generated using an irradiance model.

In the example embodiment, the irradiance model is a “clear sky model” (“CSM”) representing the expected irradiance at the location of an irradiance sensor during a particular day and time under clear sky conditions. Accordingly, CSMs estimate solar radiation under a cloudless sky as a function of the position of the sun, attributes of a location such as geographic features, and atmospheric conditions associated with the location of the irradiance sensor. The irradiance estimate represents data from the irradiance model associated with a particular location in a particular time period. As described herein, the CSM further accounts for the expected irradiance in the plane and orientation of the irradiance sensor.

In the example embodiment, at least one CSM is stored and served from the irradiance analysis computing device. The CSM may be stored in a database associated with the irradiance analysis computing device. In other embodiments, the irradiance analysis computing device may retrieve CSMs and/or irradiance estimates from an external system in networked communication with the irradiance analysis computing device.

The irradiance analysis computing device also receives a first irradiance value associated with at least one irradiance sensor. In the example embodiment, the at least one irradiance sensor is a pyranometer, described in detail below. The pyranometer is configured to measure the total level of solar irradiation for a full hemisphere (i.e., 180 degrees of field of view).

A pyranometer includes a sensor with a coating configured to absorb substantially all solar radiation across a flat spectrum from 300 to 50,000 nanometers. The sensor may be of a pyranometer type or a photodiode type. The response to beam radiation varies with the cosine of the angle of incidence so that there will be full response when solar radiation hits the irradiance sensor perpendicularly (i.e., 0 degrees angle of incidence) and no response when the sun is at the horizon (i.e., 90 degrees angle of incidence). In the example embodiment, the thermopile sensor has a near-perfect cosine response or directional response.

Functionally, the coating of the thermopile sensor absorbs solar radiation that is converted to heat and further transmitted through the sensor. In the example embodiment, the coating of the thermopile sensor is substantially black. In response to the heat, the thermopile sensor generates a voltage output proportional to the solar radiation. The voltage output may be measured in watts per meter square. The voltage output of the pyranometer can be used to identify a measurement of the solar irradiance in the location and orientation of the pyranometer.

In the example embodiment, the pyranometer also includes a plurality of glass domes configured to limit the spectral response above 2,800 nanometers. The glass domes additionally serve to shield the thermopile sensor from convection as well as from weather and other external elements. In at least some examples, the pyranometer adheres to the standards in ISO 9060 issued by the International Organization for Standardization and adopted by the World Meteorological Organization.

In an alternative embodiment, the at least one irradiance sensor is a photovoltaic reference cell (“reference cell”). A reference cell functionally measures irradiance by detecting photons with an energy level that exceeds the energy range where no electron states may exist for the photovoltaic material. This energy range is known as the band gap for the PV material. The detected photons are converted directly into positive and negative charges that may be collected and used by an external circuit. The reference cell thus generates a current dependent on the number and spectral distribution of photons with energy levels above the band gap energy range.

In some examples, current levels of reference cells are measured by measuring the voltage across a small resistor. The voltage is calibrated under the reference spectrum (as defined by, e.g., ASTM G173) at 1000 W/m² at 25° C. using techniques consistent with IEC 60904. Because reference cells are made from photovoltaic material, they can closely match PV panels in terms of spectral response. Similarly, they can closely match PV panels in terms of temperature response, angle of incidence, and time of response.

In other embodiments, any suitable irradiance sensor may be used.

The irradiance sensor suitably includes an output capable of transmitting the voltage output from the irradiance sensor to a gateway device. In one example, the gateway device is a simple computing device including a processor, a memory, data input modules, and data output modules. The data input modules are configured to receive the irradiance measurement or the voltage output from the irradiance sensor.

As described herein, the gateway device is configured to further transmit the value of the voltage output or the irradiance measurement to the irradiance analysis computing device. The gateway device may be associated with the PV module. The gateway device may communicate with the irradiance analysis computing device via wired or wireless communication. The gateway device may further collect additional data associated with the irradiance measurement or the voltage output. For example, the gateway device may collect take direct current production values from the PV system and date-stamp values associated with the time of data collection.

As indicated above and herein, the irradiance profile of the irradiance sensor and the calibration of the irradiance sensor depend upon an irradiance metric generated based on the irradiance estimate and the first irradiance value. Accordingly, as irradiance varies by day and time in a given location, the time window for the irradiance estimate and the first irradiance value are selected to significantly overlap. Each irradiance estimate and first irradiance value is stored with an associated date-stamp indicating the date and time associated with the data.

In a first example, a user may select a particular window of time from which to receive the irradiance estimate and the first irradiance value. In this example, the window of time is selected at least in part based on the fact that it is associated with a clear sky.

In a second example, the irradiance analysis computing device retrieves meteorological data to determine windows of time associated with clear skies in the location of the irradiance sensor. The meteorological data may be stored on the irradiance analysis computing device or on an associated system in communication with the irradiance analysis computing device. Accordingly, the irradiance analysis computing device identifies clear days based on the meteorological data and retrieves irradiance estimates and first irradiance values associated with such clear days.

Meteorological data may be specific enough to identify cloudless periods of time in shorter intervals such as clear hours and clear minutes. Accordingly, in such examples, the irradiance analysis computing device identifies clear periods based on the meteorological data and retrieves irradiance estimates and first irradiance values associated with such clear periods.

The irradiance analysis computing device may also suitably receive an irradiance reference value. The irradiance reference value is substantially a proxy for a second irradiance value. In examples where the irradiance reference value is received, the irradiance reference value may be used to validate, supplement, or replace the first irradiance value, as described below. As described above, the irradiance value substantially correlates with the PV system output. Accordingly, in one example, a direct current production value associated with the PV system functions as the irradiance reference value. The irradiance analysis computing device can therefore use the irradiance reference value for additional calibration as described herein. In examples where the direct current production value (or any other irradiance reference value) is received, the irradiance analysis computing device may substantially triangulate the irradiance estimate, the first irradiance value, and the irradiance reference value to improve the calibration of the irradiance sensors. In such examples, the irradiance analysis computing device receives the irradiance reference value via the gateway device described above.

The irradiance analysis computing device further processes received irradiance estimate and a first irradiance value to generate at least one irradiance metric. The irradiance metric functions as a reference value indicating the clearness of a given day of measurement. The irradiance metric is also used to determine the state of the irradiance sensor. Additionally, the irradiance metric may be used to calibrate the irradiance sensor. The irradiance metric may alternately be referred to as a “calibration factor.” As described below, such irradiance metrics or calibration factors may be used in three distinct manners. First, the irradiance analysis computing device may include alerting rules (defined by default or by system users) to alert users (e.g., analysts or technicians) of irradiance metrics that are unacceptable to create follow-up servicing or maintenance of irradiance sensors. Second, irradiance metrics or calibration factors may be used to adjust historical data analysis efforts. For example, the irradiance metric may be used to determine whether irradiance sensors have been subjected to variant levels of soiling or degradation than previously determined. Third, irradiance metrics may be used to adjust subsets of historical insolation that have been determined to be incorrect.

In a first example, the irradiance metric is a clear day metric (“CDM”). The CDM substantially represents a determination of the variance of the measured first irradiance value from the expected value associated with a clear day for the irradiance sensor measuring the value. Lower values of CDM substantially represent lower variance from the expected value associated with a clear day.

Generally speaking, CDM is calculated in the following steps, elaborated in greater detail below. The measured first irradiance value and the irradiance estimate are scaled and normalized to ensure that the data samples are suitably similar for comparison. The measured first irradiance value and the irradiance estimate are converted to profiles. The profiles represent models of the first irradiance value and the irradiance estimate. Derivatives of the profiles are determined to identify the slope of the function for the first irradiance value and the slope of the function for the irradiance estimate. Finally, mean absolute errors are calculated between the derivatives of the profiles.

Upon receipt of the irradiance estimate, the irradiance analysis computing device scales the irradiance estimate and the first irradiance value such that the maximum value of the irradiance in received data occurs at the same time stamps. Functionally, the irradiance analysis computing device identifies windows of time where the maximum values for irradiance of the irradiance estimate and the first irradiance value coincide. In at least one example embodiment, the window of time is set for four hours. In other examples, any suitable window length may be used.

The irradiance analysis computing device additionally determines functions associated with the scaled irradiance estimate and the scaled first irradiance value. The functions may be derived using any suitable method of modeling including, for example, linear regressions, multivariate linear regressions, and estimation methods. In the example embodiment, a linear regression is performed. Such functions are referred to as profiles. The profile associated with the scaled irradiance estimate may be referred to as “clear sky irradiance” (“CSI”) and the profile associated with the measured first irradiance value may be referred to as the “pyranometer irradiance” (“PYR”).

Derivatives of the CSI profile and the PYR profile are taken. By utilizing the derivative or slope of the profiles, comparisons between the profiles can more easily be determined. In the example embodiment, the derivatives of the CSI profile and the PYR profile are compared using a mean absolute error (“MAE”) approach. MAE substantially represents comparing a forecasted value (f) with a measured value (y) to identify errors in forecasting. Herein, the forecasted value f is represented by the CSI profile because the CSI profile is based on a model of expected irradiance for a given location and orientation on a cloudless day. The measured value y is represented by the PYR profile because the PYR profile is based on a model of measured irradiance at the irradiance sensor. MAE substantially allows for generating a straightforward metric showing variance between CSI profiles and PYR profiles. A standard equation illustrating the MAE approach is given below in Equation 1.

$$\frac{1}{n} {\sum }_{i = 1}^{n} \vert {f}_{i}^{′} - {y}_{i}^{′} \vert = \frac{1}{n} {\sum }_{i = 1}^{n} \vert {e}_{i} \vert \qquad Equation 1$$

Accordingly, Equation 1 represents an average of the absolute value of errors in the estimation of CSI for actual measured values of PYR. Equation 1 is an average of the summation of the differences of the slopes of CSI and PYR. Equation 1 illustrates a general approach to MAE. However, Equation 2 below more clearly illustrates an MAE approach for comparing the derivative of CSI to the derivative of PYR.

$$\frac{1}{n} {\sum }_{k = 1}^{n} \vert \frac{\partial {( CSI )}_{k}}{\partial t} - \frac{\partial {( PYR )}_{k}}{\partial t} \vert \qquad Equation 2$$

In the example embodiment, Equation 2 yields a CDM value. As Equation 2 measures the error in CSI's estimation of PYR, CDM approaches zero as the irradiance sensor is more accurate.

In other examples, other algorithms or approaches may be used to determine the relative accuracy of PYR with respect to CSI. For example, mean squared error, root mean squared error, and mean percentage error may be used. Alternately, any other suitable algorithm or approach may be used.

In a second example, the irradiance metric may be a clearness factor (“CF”). In the example embodiment, CF is given Equation 3 below:

$$( \frac{1}{n} {\sum }_{i = 1}^{n} {( PYR )}_{i} ) / ( \frac{1}{n} {\sum }_{j = 1}^{n} {( CSI )}_{j} ) \qquad Equation 3$$

In other words, CF is calculated by dividing the average of measured first irradiance values by the average of the irradiance estimates. Accordingly, a CF value of 1.0 indicates that the irradiance sensor is well calibrated while higher and lower values indicate that the irradiance sensor may require re-calibration.

Irradiance metrics may be less useful when they fall out of particular ranges of values. For example, CDM values exceeding 0.75 are not useful for calibration purposes. In at least some examples, a predefined threshold may be set in order to ignore irradiance metrics that fall above or below the threshold. The predefined threshold may be set by a user of the irradiance analysis computing device or by system defaults. Accordingly, when a minimum threshold is set for irradiance metrics, any values falling below the threshold may be disregarded. Alternatively, when a maximum threshold is set, any values above the threshold may similarly be disregarded. Further, the predefined threshold may be set as a variance from a base value. For example, since a well calibrated irradiance sensor is indicated by a CF value of 1.0, a predefined threshold may be set to ignore values varying from 1.0 by more than 0.6.

Multiple irradiance metrics, e.g., CDM and CF metrics, are generated in some embodiments. In such embodiments, the multiple irradiance metrics may be used together to determine the irradiance profile, state of the irradiance sensor, and provide information on calibration.

In at least one example, CDM is used to identify time-periods to ignore (e.g., when CDM values fall below 0.75). Accordingly, CDM is used to screen out particular time-periods. CF values may then be analyzed for the remaining time-periods to identify trends. For example, CF values that steadily move away from 1.0 in one direction may indicate that the irradiance sensor is becoming increasingly inaccurate. Similarly, trends for CDM may be analyzed by the irradiance analysis computing device. As CDM values rise, the irradiance analysis computing device may determine that the irradiance sensor is becoming increasingly inaccurate.

As noted above, an irradiance reference value is received in some embodiments. The irradiance reference value suitably represents a direct current output of the PV system. In these embodiments, the irradiance reference value may be processed using methods described herein to create a second irradiance metric. For example, the irradiance reference metric may be used to create a calculation similar to a CDM or CF. Accordingly, this second irradiance metric may be useful to validate whether an irradiance sensor is in an anomalous state.

In operation, some variation between measured first irradiance values and estimated irradiance may be acceptable. Estimated irradiance is a simulation and may have some degree of error built in. Further, fluctuations in weather may cause slight discrepancies between measured first irradiance values and estimated irradiance even using properly calibrated irradiance sensors. Accordingly, the irradiance analysis computing device may utilize an uncertainty band (“cu band”) representing a tolerance of a variance of irradiance metrics. For example, a cu band for CF may be from 0.95 to 1.05. Similarly, a cu band for CDM may be from 0 to 0.1. Additionally, a confidence score may be determined to indicate the degree to which a particular irradiance metric appears reliable. The confidence score may be determined using any suitable statistical method. By using confidence scores and cu bands, the irradiance analysis computing device may identify anomalous irradiance metrics in a more precise manner and thereby minimize false-positive identifications.

The irradiance analysis computing device may consider one or a plurality of irradiance metrics to identify irradiance sensors that may be in an anomalous state. The irradiance analysis computing device suitably looks for individual variances in irradiance metrics and identifies anomalies. For example, the irradiance analysis computing device may identify every irradiance sensor deviating from a CF value of 1.0. In other examples, the irradiance analysis computing device may identify irradiance sensors as anomalous based on trend analyses of multiple irradiance metrics (e.g., considering changes in irradiance metrics over time for a particular irradiance sensor.) In additional examples, the irradiance analysis computing device may utilize cu bands to set a tolerance threshold for irradiance metrics. In still other examples, the irradiance analysis computing device may use confidence intervals to determine the likelihood that an irradiance metric is accurate.

Upon determining that an irradiance sensor is potentially in an anomalous state, the irradiance analysis computing device may issue an alert. The alert may be sent to an analyst or a technician. The alert may be sent using any suitable method including, for example, email, SMS, or web services. In further examples, the alert may be stored in an analytics system to track the history of the irradiance analysis computing device.

In addition, the irradiance metrics determined by the irradiance analysis computing device may be used to re-calibrate the irradiance sensors. Upon identifying a repeated deviation between data from the CSI profile and data from the PYR profile, the deviation can be used as a calibration data point to reconcile CSI profile data with PYR profile data.

A variant CF value (e.g., a CF value significantly different from 1.0) and a low CDM value may not indicate a problem with an irradiance sensor. In these examples, the CSM may have inaccuracies. Accordingly, when the irradiance analysis computing device triggers an alert, a technician or analyst may inspect an irradiance sensor or PV system and provide any necessary maintenance or servicing.

The analyst may then determine that the CSM requires modification. Accordingly, the system and method further allows for the enhancement of CSMs.

In at least some examples, the irradiance analysis computing device also facilitates performance reporting, comparative analysis, performance diagnostics, and energy estimation validation. More specifically, the irradiance analysis computing device generates irradiance metrics (or calibration factors) that may be used to correct or adjust data related to the output of PV systems. Additionally, the irradiance analysis computing device may be used to generate comparative analysis reports by comparing output and irradiance information for PV systems of different locations, designs, and technologies. Further, the irradiance analysis computing device may be used to diagnose system performance and identify drift, soiling, degradation, and otherwise determine a characterization for irradiance sensors and PV systems.

A technical effect of the systems and methods described herein include at least one of (a) alert analysts and maintenance professionals to irradiance sensors operating in an abnormal state; (b) increasing the confidence of performance impairment identification in PV systems; (c) improving historical data when irradiance sensors have previously gone into abnormal states to improve time-series analysis; and (d) improving the energy production from PV systems through improved calibration of irradiance sensors and PV systems.

More specifically, such technical effects can be achieved by performing at least one of the following steps: (a) receiving an irradiance estimate representing an expected amount of irradiance; (b) receiving a first irradiance value associated with at least one irradiance sensor; (c) processing the irradiance estimate and the first irradiance value to generate at least one irradiance metric; (d) determining whether the at least one irradiance sensor is in a normal condition or an anomalous condition based at least in part on the at least one irradiance metric; (e) generating the irradiance estimate using an irradiance model; (f) generating the irradiance estimate based on at least one of a location, a system orientation, a date, and a time; (g) receiving the first irradiance value from an irradiance sensor, the irradiance sensor representing at least one of a pyranometer and a reference cell; (h) receiving an irradiance reference value wherein the irradiance reference value is a proxy for a second irradiance value; (i) processing the irradiance reference value, the irradiance estimate, and the first irradiance value to generate a second irradiance metric; (j) determining whether the at least one irradiance sensor is in a normal condition or an anomalous condition based at least in part on the second irradiance metric; (k) normalizing the received irradiance estimate and the first irradiance value; (l) determining whether the at least one irradiance sensor is at least one of miscalibrated, misoriented, obstructed, soiled, and otherwise impaired; (m) receiving the first irradiance value from an irradiance sensor in communication with the irradiance analysis computing device via wired or wireless networks; (n) identify a minimum threshold value for the at least one irradiance metric and ignore irradiance metrics falling below the predetermined threshold; and (o) determine a confidence value associated with the at least one irradiance metric.

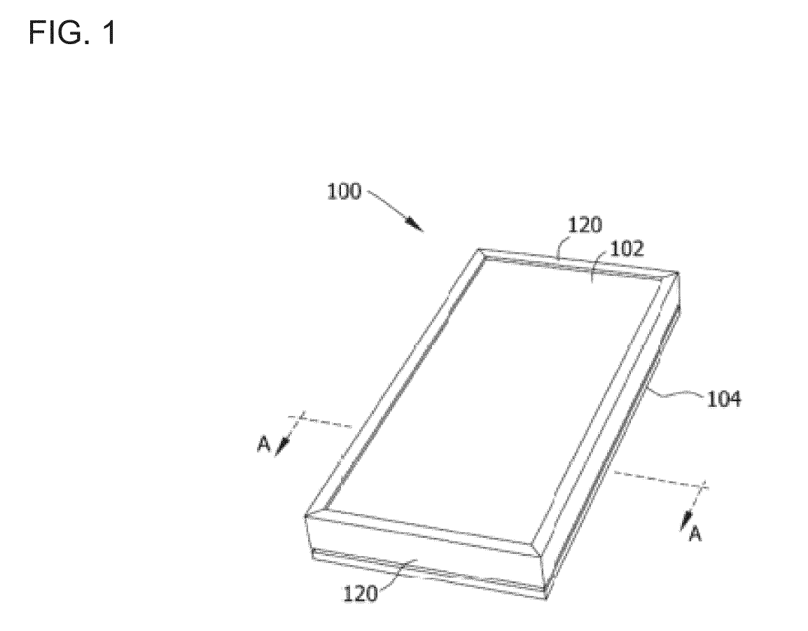

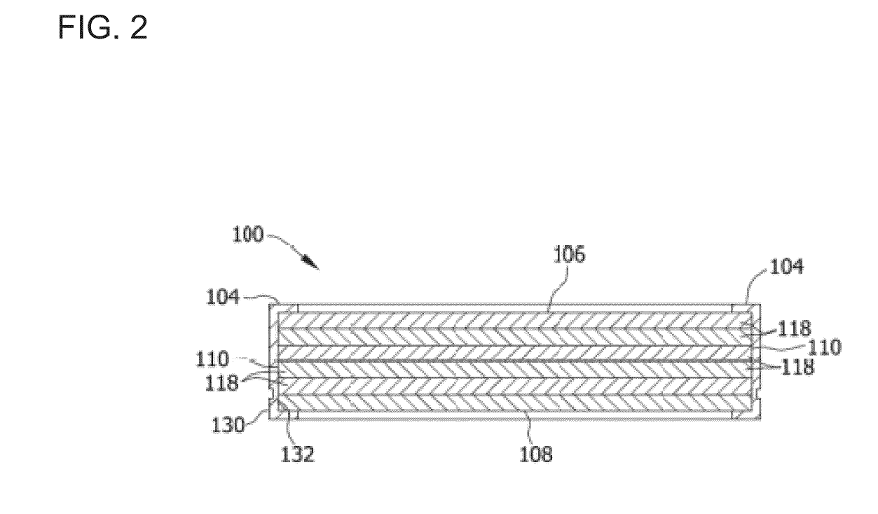

Referring initially to FIGS. 1 and 2, a PV module is indicated generally at 100. A perspective view of the PV module 100 is shown in FIG. 1. FIG. 2 is a cross sectional view of the PV module 100 taken at line A-A shown in FIG. 1. The PV module 100 includes a solar laminate 102 (also referred to as a PV laminate) and a frame 104 circumscribing the solar laminate 102.

The solar laminate 102 includes a top surface 106 and a bottom surface 108 (shown in FIG. 2). Edges 110 extend between the top surface 106 and the bottom surface 108. In this embodiment, the solar laminate 102 is rectangular shaped. In other embodiments, the solar laminate 102 may have any suitable shape.

As shown in FIG. 2, the solar laminate 102 has a laminate structure that includes several layers 118. Layers 118 may include for example glass layers, non-reflective layers, electrical connection layers, n-type silicon layers, p-type silicon layers, and/or backing layers. In other embodiments, solar laminate 102 may have more or fewer layers 118, including only one layer, or may have different layers 118, and/or may have different types of layers 118. The solar laminate 102 includes a plurality of solar cells (not shown), each of which converts solar energy to electrical energy. The outputs of the solar cells are connected in series and/or parallel to produce the desired output voltage and current for the solar laminate 102.

As shown in FIG. 1, the frame 104 circumscribes the solar laminate 102. The frame 104 is coupled to the solar laminate 102, as best seen in FIG. 2. The frame 104 assists in protecting the edges 110 of the solar laminate 102. In this embodiment, the frame 104 is constructed of four frame members 120. In other embodiments the frame 104 may include more or fewer frame members 120.

This frame 104 includes an outer surface 130 spaced apart from solar laminate 102 and an inner surface 132 adjacent solar laminate 102. The outer surface 130 is spaced apart from and substantially parallel to the inner surface 132. In this embodiment, the frame 104 is made of aluminum. More particularly, in some embodiments the frame 104 is made of 6000 series anodized aluminum. In other embodiments, the frame 104 may be made of any other suitable material providing sufficient rigidity including, for example, rolled or stamped stainless steel, plastic, or carbon fiber.

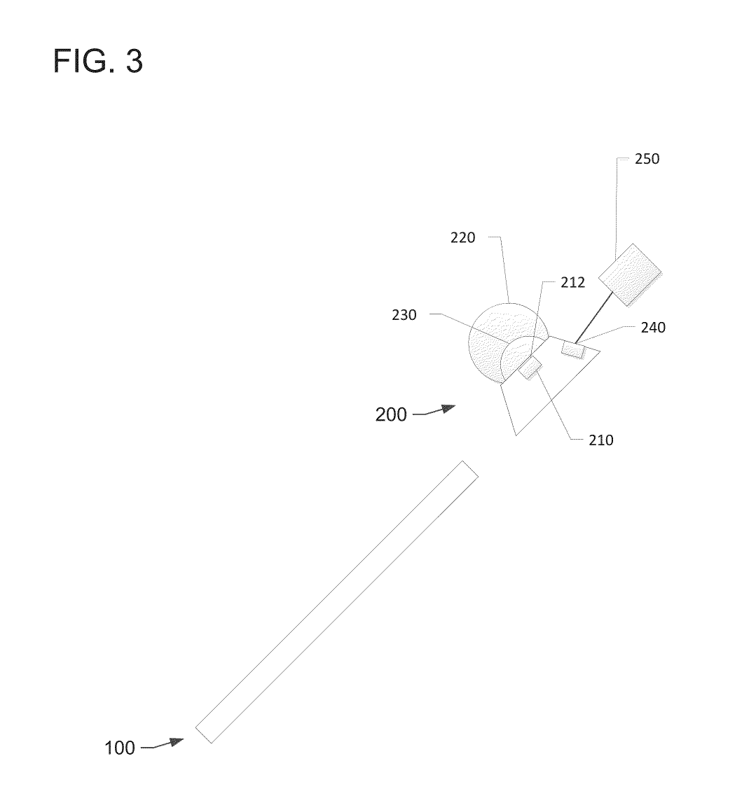

Referring to FIG. 3, pyranometer 200 is shown in relation to PV module 100 of FIGS. 1 and 2. Pyranometer 200 is configured to measure the total level of solar irradiation for a full hemisphere (i.e., 180 degrees of field of view). Pyranometer 200 measures such solar radiation received at sensor 210. Sensor 210 receives radiation at a plane parallel to the solar laminate 102 of PV module 100. Accordingly, sensor 210 and pyranometer 200 substantially measure irradiance at PV module 100.

Sensor 210 is a thermopile sensor with a coating 212 configured to absorb substantially all solar radiation across a flat spectrum from 300 to 50,000 nanometers. The response to beam radiation varies with the cosine of the angle of incidence so that there will be full response when solar radiation hits sensor 210 perpendicularly (i.e., 0 degrees angle of incidence) and no response when the sun is at the horizon (i.e., 90 degrees angle of incidence). In the example embodiment, the sensor 210 accordingly has a near-perfect cosine response or directional response.

Functionally, coating 212 of the sensor 210 absorbs solar radiation that is converted to heat and further transmitted through sensor 210. In the example embodiment, coating 212 is substantially black. In response to the heat, sensor 210 generates a voltage output proportional to the solar radiation. The voltage output may be measured in watts per meter square. Accordingly, the voltage output of pyranometer 200 can be used to identify a measurement of the solar irradiance in the location and orientation of pyranometer 200 and therefore in the location and orientation of PV module 100.

In the example embodiment, pyranometer 200 also includes a plurality of glass domes 220 and 230 configured to limit the spectral response above 2,800 nanometers. Glass domes 220 and 230 additionally serve to shield sensor 210 from convection and impact from weather and other external elements. In at least some examples, pyranometer 200 adheres to the standards in ISO 9060 issued by the International Organization for Standardization and adopted by the World Meteorological Organization.

Pyranometer 200 further includes an output 240 capable of transmitting the voltage output from to a gateway device 250. In the example embodiment, gateway device 250 is a simple computing device including a processor, a memory, data input modules, and data output modules. The data input modules are configured to receive the irradiance measurement or the voltage output from pyranometer 200.

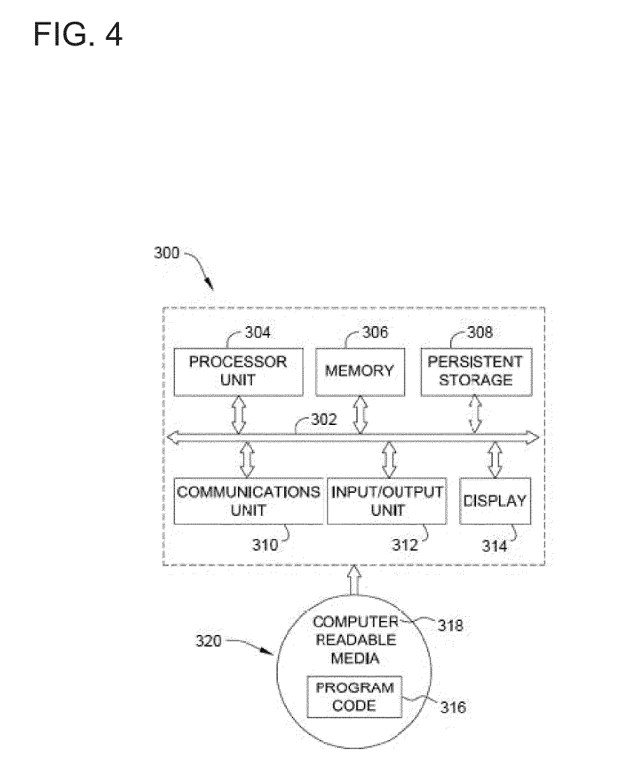

As described herein, gateway device 250 is configured to further transmit the value of the voltage output or the irradiance measurement to an irradiance analysis computing device (shown in FIG. 4). Gateway device 250 may be also associated with PV module 100. Gateway device 250 may communicate with the irradiance analysis computing device via wired or wireless communication. Gateway device 250 may further collect additional data associated with the irradiance measurement or the voltage output. For example, gateway device 250 may collect take direct current production values from PV system 100 and date-stamp values associated with the time of data collection.

In other embodiments (not shown), other irradiance sensors may be used with the systems described herein. For example, sensor 210 may function separately from pyranometer 200. Alternately, any suitable irradiance sensor may be used with the systems and methods described herein.

Some example methods and systems are performed using and/or include computing devices. FIG. 4 is a block diagram of an example computing device 300. More specifically, computing device 300 represents an example embodiment of an irradiance analysis computing device. In the example implementation, computing device 300 includes communications fabric 302 that provides communications between a processor unit 304, a memory 306, persistent storage 308, a communications unit 310, an input/output (I/O) unit 312, and a presentation interface, such as a display 314. In addition to, or in alternative to, the presentation interface may include an audio device (not shown) and/or any device capable of conveying information to a user.

Processor unit 304 executes instructions for software that may be loaded into a storage device (e.g., memory 306). Processor unit 304 may be a set of one or more processors or may include multiple processor cores, depending on the particular implementation. Further, processor unit 304 may be implemented using one or more heterogeneous processor systems in which a main processor is present with secondary processors on a single chip. In another implementation, processor unit 304 may be a homogeneous processor system containing multiple processors of the same type.

Memory 306 and persistent storage 308 are examples of storage devices. As used herein, a storage device is any tangible piece of hardware that is capable of storing information either on a temporary basis and/or a permanent basis. Memory 306 may be, for example, without limitation, random access memory (RAM) such as dynamic RAM (DRAM) or static RAM (SRAM), read-only memory (ROM), erasable programmable read-only memory (EPROM), electrically erasable programmable read-only memory (EEPROM), non-volatile RAM (NVRAM), and/or any other suitable volatile or non-volatile storage device. Persistent storage 308 may take various forms depending on the particular implementation, and persistent storage 308 may contain one or more components or devices. For example, persistent storage 308 may be one or more hard drives, flash memory, rewritable optical disks, rewritable magnetic tapes, and/or some combination of the above. The media used by persistent storage 308 also may be removable. For example, without limitation, a removable hard drive may be used for persistent storage 308.

A storage device, such as memory 306 and/or persistent storage 308, may be configured to store data for use with the processes described herein. For example, a storage device may store (e.g., have embodied thereon) computer-executable instructions, executable software components, PV system component data, PV system layouts, installation instructions, work orders, and/or any other information suitable for use with the methods described herein. When executed by a processor (e.g., processor unit 304), such computer-executable instructions and/or components cause the processor to perform one or more of the operations described herein.

Communications unit 310, in these examples, provides for communications with other computing devices or systems. In the example implementation, communications unit 310 is a network interface card. Communications unit 310 may provide communications through the use of either or both physical and wireless communication links. Communication unit 310 provides communication to one or more element of the PV system.

Input/output unit 312 enables input and output of data with other devices that may be connected to computing device 300. For example, without limitation, input/output unit 312 may provide a connection for user input through a user input device, such as a keyboard and/or a mouse. Further, input/output unit 312 may send output to a printer. Display 314 provides a mechanism to display information, such as any information described herein, to a user. For example, a presentation interface such as display 314 may display a graphical user interface, such as those described herein. The communication device 310 may include one or more analog I/O.

Instructions for the operating system and applications or programs are located on persistent storage 308. These instructions may be loaded into memory 306 for execution by processor unit 304. The processes of the different implementations may be performed by processor unit 304 using computer implemented instructions and/or computer-executable instructions, which may be located in a memory, such as memory 306. These instructions are referred to herein as program code (e.g., object code and/or source code) that may be read and executed by a processor in processor unit 304. The program code in the different implementations may be embodied in a non-transitory form on different physical or tangible computer-readable media, such as memory 306 or persistent storage 308.

Program code 316 is located in a functional form on non-transitory computer-readable media 318 that is selectively removable and may be loaded onto or transferred to computing device 300 for execution by processor unit 304. Program code 316 and computer-readable media 318 form computer program product 120 in these examples. In one example, computer-readable media 318 may be in a tangible form, such as, for example, an optical or magnetic disc that is inserted or placed into a drive or other device that is part of persistent storage 308 for transfer onto a storage device, such as a hard drive that is part of persistent storage 308. In a tangible form, computer-readable media 318 also may take the form of a persistent storage, such as a hard drive, a thumb drive, or a flash memory that is connected to computing device 300. The tangible form of computer-readable media 318 is also referred to as computer recordable storage media. In some instances, computer-readable media 318 may not be removable.

Alternatively, program code 316 may be transferred to computing device 300 from computer-readable media 318 through a communications link to communications unit 310 and/or through a connection to input/output unit 312. The communications link and/or the connection may be physical or wireless in the illustrative examples. The computer-readable media also may take the form of non-tangible media, such as communications links or wireless transmissions containing the program code.

In some illustrative implementations, program code 316 may be downloaded over a network to persistent storage 308 from another computing device or computer system for use within computing device 300. For instance, program code stored in a computer-readable storage medium in a server computing device may be downloaded over a network from the server to computing device 300. The computing device providing program code 316 may be a server computer, a workstation, a client computer, or some other device capable of storing and transmitting program code 316.

Program code 316 may be organized into computer-executable components that are functionally related. Each component may include computer-executable instructions that, when executed by processor unit 304, cause processor unit 304 to perform one or more of the operations described herein.

The different components illustrated herein for computing device 300 are not meant to provide architectural limitations to the manner in which different implementations may be implemented. The different illustrative implementations may be implemented in a computer system including components in addition to or in place of those illustrated for computing device 300. For example, in some embodiments, computing device includes a global positioning system (GPS) receiver. Moreover, components shown in FIG. 3 can be varied from the illustrative examples shown. As one example, a storage device in computing device 300 is any hardware apparatus that may store data. Memory 306, persistent storage 308 and computer-readable media 318 are examples of storage devices in a tangible form.

In another example, a bus system may be used to implement communications fabric 302 and may include one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, without limitation, memory 306 or a cache such as that found in an interface and memory controller hub that may be present in communications fabric 302.

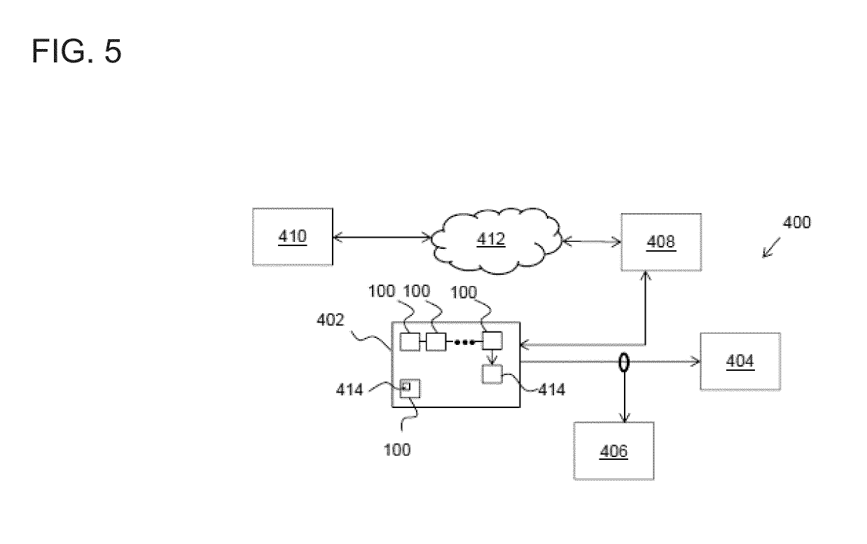

FIG. 5 is a block diagram of an example PV system 400. The PV system 400 includes an array 402 of PV modules 100 and one or more inverters. The array 402 outputs AC power to one or more loads 404. A meter 406 measures the power delivered to the loads 404. A gateway device 408, also referred to as a data acquisition device, a data logger, or a data acquisition system (DAS), monitors the array 402 and transmits data collected from the array 402 to a backend system 410 via a network 412. Backend system 410 includes one or more computing devices 300. Backend system 410 is usually located at a second location physically separated from the first location at which PV system 400 is located. Alternatively, the second system may be located at the same site as the PV system 400. Moreover, the gateway device 408 may provide information to and communicate with more than one backend systems 410. The distance between the first location and the second location will vary among installed PV systems 400. In some embodiments, the first location and the second location are greater than five miles apart. In other embodiments, the first and second locations are more than ten miles apart, 25 miles apart, 50 miles apart, 100 miles apart, 200 miles apart, or even located on different continents.

The array 402 may be any suitable array of PV modules 100 and one or more inverters 414. For example, the array 402 may include a plurality of PV modules arranged in strings of PV modules. Each string of modules is connected to a single inverter to convert the DC output of the string of PV modules to an AC output. Alternatively, or additionally, each PV module may be coupled to its own inverter 414 (sometimes referred to as a microinverter) positioned near or on the PV module to which it is electrically coupled. In still other examples, a plurality of strings of PV modules may be connected, directly or through one or more string combiners, to a single inverter 414, sometimes referred to as a central or string inverter.

In embodiments that do not include microinverters, the array 402 may include a direct current power manager (DCPM) coupled to each PV module. The DCPM performs, for example, maximum power point tracking (MPPT) for the PV module. It may also selectively control (i.e., limit and/or increase) the maximum power output of the PV module and/or control the conduction of bypass diodes based on temperature and bypass current. The DCPM may also translates the output I-V curve of the PV module to a new I-V curve at which the output voltage does not vary with ambient temperature.

In some embodiments, the array 402 includes one or more tracking devices configured to selectively position the PV modules relative to the sun to attempt to maximize the solar energy incident on the PV modules over time. Any other suitable arrangement of PV modules and inverter(s) may be used, including combinations of the arrangements described above.

The gateway device 408 collects data concerning array 402, such as via one or more sensors (not shown). The gateway device 408 is and/or includes a computing device, such as computing device 300. The collected data may include any appropriate operational, situational, environmental, or other data related to the operation and/or condition of the array 402. For example, the gateway may monitor the ambient air temperature around the array 402, the amount of sunlight incident on the array 402 (or one or more PV module), the output voltage and current of the array 402, the output voltage and current of each PV module, the output voltage and current of each inverter and/or microinverter 414, the surface temperature of the PV modules 100, etc. Moreover, in some embodiments, the gateway device 408 is in communication with one or more components of the array 402. For example, the gateway device 408 may be in communication with one or more inverters 414 in the array 402. Each inverter 414 may provide the gateway device 408 with, for example, its input voltage, its input current, its output voltage, its output current, etc. In some embodiments, the array 402 (and more particularly the inverters 414) may be controlled via the gateway device 408.

In one example, the network 412 is the Internet. In other implementations, network 412 is any other suitable communication network, including, for example, a wide area network (WAN), a local area network (LAN), a cellular network, etc. Network 412 may include more than one network. For example, gateway device 408 may connect to the Internet through one or more other networks and/or interfaces, such as a local area network (LAN), a wide area network (WAN), a home area network (HAN), dial-in-connections, cable modems, and high-speed ISDN lines.

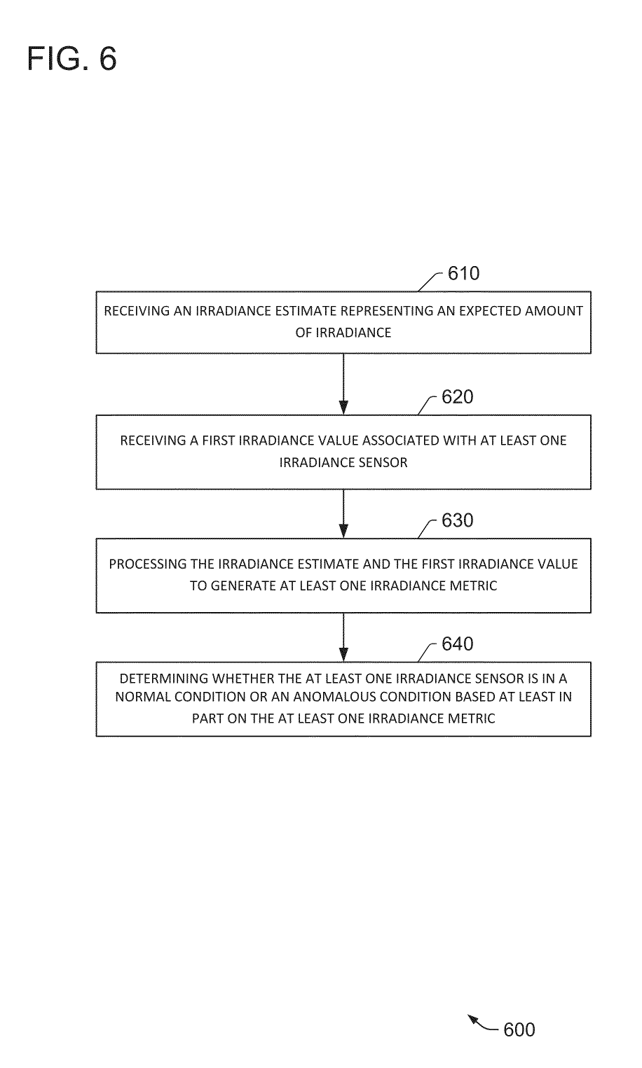

FIG. 6 is a flow diagram of an example method 600 of determining irradiance profiles for irradiance sensors. The method is implemented by irradiance analysis computing device 300. Irradiance analysis computing device 300 receives 610 an irradiance estimate representing an expected amount of irradiance. In the example embodiment, receiving 610 represents receiving an irradiance estimate generated by an irradiance model such as a clear sky model (“CSM”). The irradiance estimate may be generated at irradiance analysis computing device 300 or at an associated system in communication with irradiance analysis computing device 300. The received irradiance estimate may be generated based on at least one a location, a system orientation, a date, and a time.

Irradiance analysis computing device 300 also receives 620 a first irradiance value associated with at least one irradiance sensor. Receiving 620 represents receiving an irradiance value from an irradiance sensor such as pyranometer 200.

Irradiance analysis computing device 300 also processes 630 the irradiance estimate and the first irradiance value to generate at least one irradiance metric. Processing 630 represents generating irradiance metrics including, for example, clear day metrics (“CDMs”) or clearness factors (“CFs”).

Irradiance analysis computing device 300 additionally determines 640 whether the at least one irradiance sensor is in a normal condition or an anomalous condition based at least in part on the at least one irradiance metric. Determining 640 represents analyzing the irradiance metric to determine whether the associated irradiance sensor is at least one of miscalibrated, misoriented, obstructed, soiled, and otherwise impaired. Determining 640 may be facilitated by using pre-determined thresholds for ignoring irradiance metrics, cu bands for setting tolerances of variance in irradiance metrics, and confidence intervals for irradiance metrics. Upon determining 640 that an irradiance sensor is in an anomalous condition, irradiance analysis computing device 300 may send an alert.

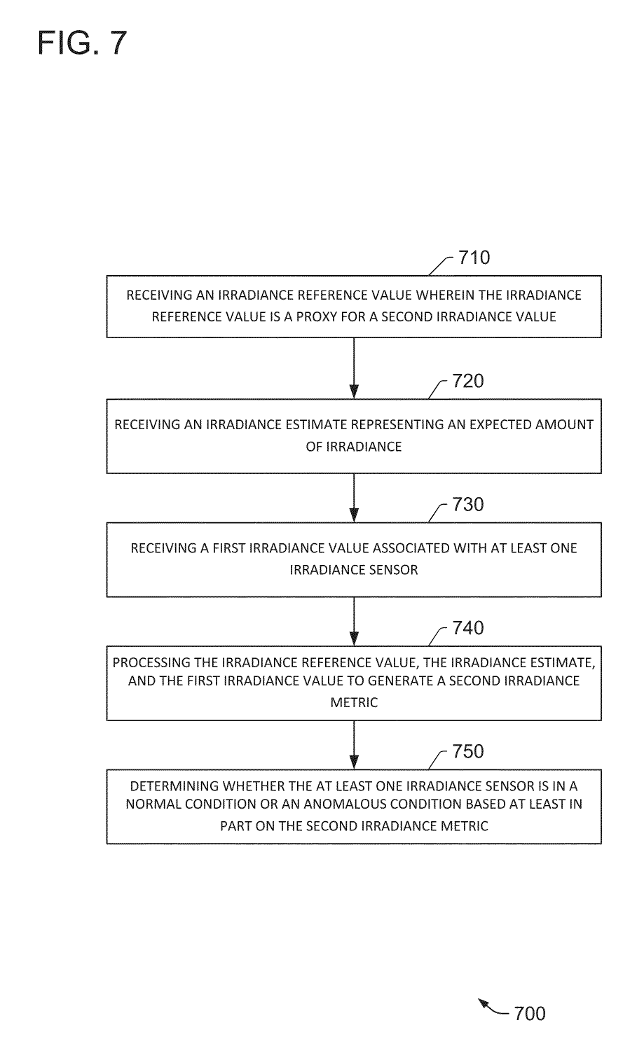

FIG. 7 is a flow diagram of another embodiment of method 700 of determining irradiance profiles for irradiance sensors. Method 700 is also implemented by irradiance analysis computing device 300. Irradiance analysis computing device 300 receives 710 an irradiance reference value wherein the irradiance reference value is a proxy for a second irradiance value. Receiving 710 represents receiving a proxy value such as a direct current output for a PV system associated with an irradiance sensor. As described herein, PV system output is correlated to measured irradiance.

Irradiance analysis computing device 300 also receives 720 an irradiance estimate representing an expected amount of irradiance. Receiving 720 is substantially the same as receiving 610 in method 600. Accordingly, receiving 720 represents receiving an irradiance estimate generated by an irradiance model such as a CSM.

Irradiance analysis computing device 300 additionally receives 730 a first irradiance value associated with at least one irradiance sensor. Receiving 730 is substantially the same as receiving 620 in method 600. Accordingly, receiving 730 represents receiving an irradiance value from an irradiance sensor such as pyranometer 200.

Irradiance analysis computing device 300 additionally processes 740 the irradiance reference value, the irradiance estimate, and the first irradiance value to generate a second irradiance metric. Processing 740 represents generating an irradiance metric to identify the variance of predicted irradiance (i.e., from the irradiance estimate) from measured irradiance (i.e., from first irradiance value and irradiance reference value.) Processing 740 may include generating second irradiance metric using methods similar to the calculations of CF or CDM. For example, second irradiance metric may be represented by a second clearness factor of the average of the irradiance reference value divided by the average of the estimated irradiance. Alternately, second irradiance metric may include a calculation identifying the variance of the irradiance reference value, the irradiance estimate, and the first irradiance value. Accordingly, any suitable error analysis may be used for processing 740.

Irradiance analysis computing device 300 additionally determines 750 whether the at least one irradiance sensor is in a normal condition or an anomalous condition based at least in part on the second irradiance metric. Determining 750 represents analyzing the second irradiance metric to determine whether the associated irradiance sensor is at least one of miscalibrated, misoriented, obstructed, soiled, and otherwise impaired. Determining 750 may be facilitated by using methods such as those described in determining 640 including using pre-determined thresholds for ignoring irradiance metrics, cu bands for setting tolerances of variance in irradiance metrics, and confidence intervals for irradiance metrics. Upon determining 750 that an irradiance sensor is in an anomalous condition, irradiance analysis computing device 300 may send an alert.

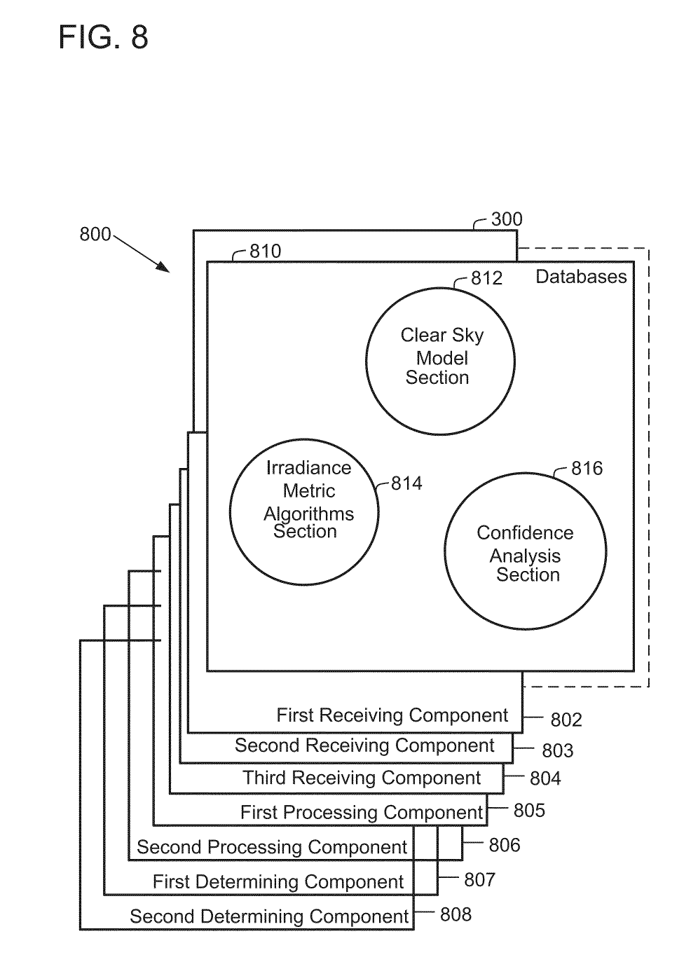

FIG. 8 is a diagram of components of example computing devices such as irradiance analysis computing device 300 (shown in FIG. 4). FIG. 8 further shows a configuration of databases including at least database 810. Database 810 is coupled to several separate components within irradiance analysis computing device 300, which perform specific tasks.

Irradiance analysis computing device 300 includes a first receiving component 802 for receiving an irradiance estimate representing an expected amount of irradiance, a second receiving component 803 for receiving a first irradiance value associated with at least one irradiance sensor, a third receiving component 804 for receiving an irradiance reference value wherein the irradiance reference value is a proxy for a second irradiance value, a first processing component 805 for processing the irradiance estimate and the first irradiance value to generate at least one irradiance metric, a second processing component 806 for processing the irradiance reference value, the irradiance estimate, and the first irradiance value to generate a second irradiance metric, a first determining component 807 for determining whether the at least one irradiance sensor is in a normal condition or an anomalous condition based at least in part on the at least one irradiance metric, and a second determining component 808 for determining whether the at least one irradiance sensor is in a normal condition or an anomalous condition based at least in part on the second irradiance metric.

In an embodiment, database 810 is divided into a plurality of sections, including but not limited to, a clear sky model section 812, an irradiance metric algorithms section 814, and a confidence analysis section 816. These sections within database 810 are interconnected to update and retrieve the information as required.

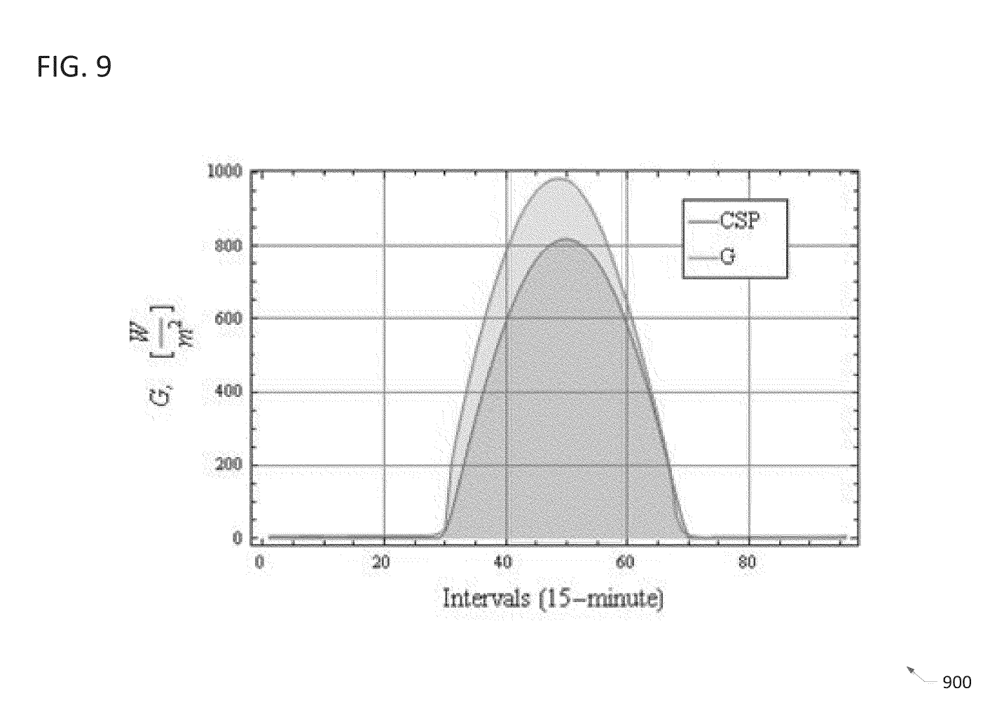

Referring to FIG. 9-12, charts are given to illustrate the comparison of irradiance estimates to first irradiance values. Referring initially to FIG. 9, a chart is given to illustrate the process of scaling. The time-window indicated between time 40 and time 60 is selected for comparison because of the nearly coincident maximum irradiance value for both curves.

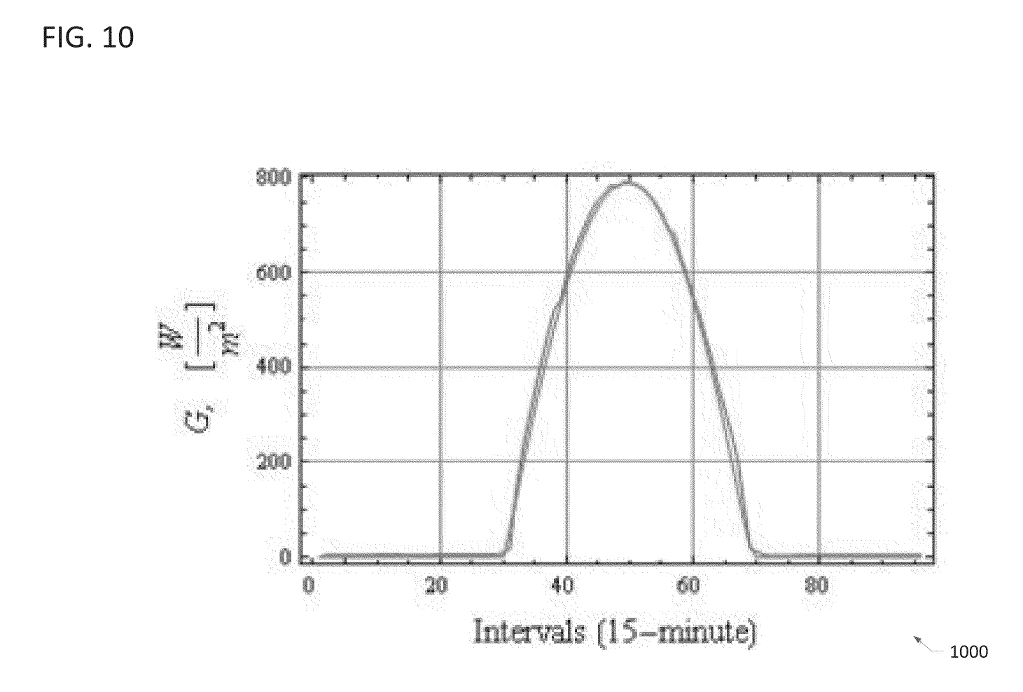

Referring to FIG. 10, a chart is given indicating a strong correlation between irradiance estimates and first irradiance values. Accordingly, FIG. 10 indicates an irradiance sensor that is well-calibrated. The Clearness Factor (“CF”) associated with FIG. 10 is 1.02 and the Clear Day Metric (“CDM”) associated with FIG. 10 is 0.103.

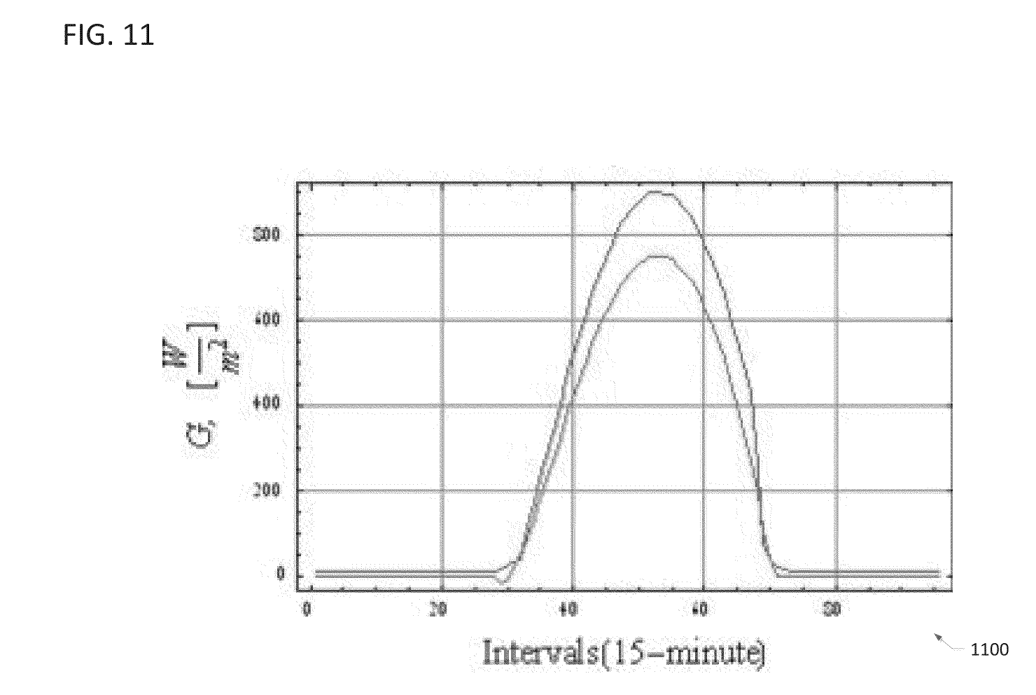

Referring to FIG. 11, a chart is given indicating a comparatively weak correlation between irradiance estimates and first irradiance values. Accordingly, FIG. 11 indicates an irradiance sensor that is potentially poorly-calibrated. The CF associated with FIG. 11 is 0.23 and the CDM associated with FIG. 11 is 7.38.

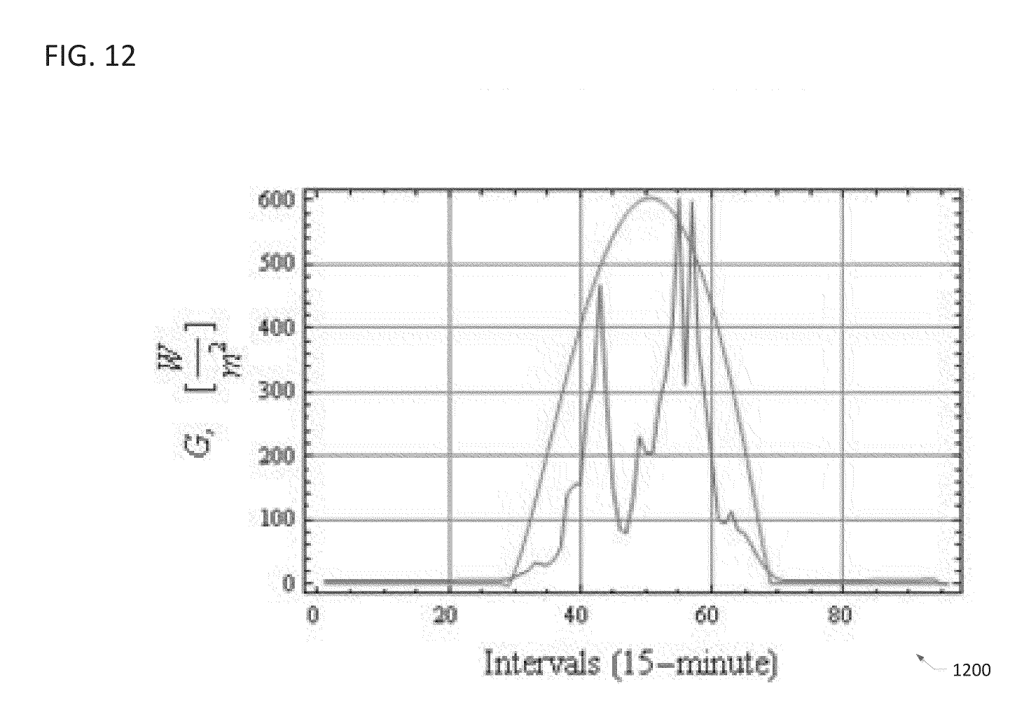

Referring to FIG. 12, a chart is given indicating a medium correlation between irradiance estimates and first irradiance values. Accordingly, FIG. 12 indicates an irradiance sensor that is potentially slightly miscalibrated. The CF associated with FIG. 2 is 1.423 and the CDM associated with FIG. 12 is 0.148.

This written description uses examples to disclose various embodiments, which include the best mode, to enable any person skilled in the art to practice those embodiments, including making and using any devices or systems and performing any incorporated methods. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

When introducing elements of the present invention or the embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above without departing from the scope of the invention, it is intended that all matter contained in the above description and shown in the accompanying drawings shall be interpreted as illustrative and not in a limiting sense.

What is claimed is:

1. A computer-implemented method for calibrating irradiance sensors implemented by an irradiance analysis computing device in communication with a memory, the method comprising:
receiving an irradiance estimate representing an expected amount of irradiance;
receiving a first irradiance value associated with at least one irradiance sensor;
processing, at the irradiance analysis computing device, the irradiance estimate and the first irradiance value to generate at least one irradiance metric; and
determining the condition of the at least one irradiance sensor based at least in part on the at least one irradiance metric.

2. The method of claim 1, further comprising:
generating the irradiance estimate using an irradiance model.

3. The method of claim 1, further comprising:
generating the irradiance estimate based on at least one of a location, a system orientation, a date, and a time.

4. The method of claim 1, wherein receiving the first irradiance value further comprises:
receiving the first irradiance value from an irradiance sensor, the irradiance sensor representing at least one of a pyranometer and a reference cell.

5. The method of claim 1, further comprising:
receiving an irradiance reference value wherein the irradiance reference value is a proxy for a second irradiance value;
processing the irradiance reference value, the irradiance estimate, and the first irradiance value to generate a second irradiance metric;
determining whether the at least one irradiance sensor is in a normal condition or an anomalous condition based at least in part on the second irradiance metric.

6. The method of claim 1, further comprising:
normalizing the received irradiance estimate and the first irradiance value.

7. The method of claim 1, wherein determining whether the at least one irradiance sensor is in a normal condition or an anomalous condition further comprises:
determining whether the at least one irradiance sensor is at least one of: miscalibrated, misoriented, obstructed, soiled, and otherwise impaired.

8. An irradiance analysis computing device used to calibrate irradiance sensors, the irradiance analysis computing device comprising:
a processor; and
a memory coupled to said processor, said processor configured to:
receive an irradiance estimate representing an expected amount of irradiance;
receive a first irradiance value associated with at least one irradiance sensor;
process the irradiance estimate and the first irradiance value to generate at least one irradiance metric; and
determine a condition of the at least one irradiance sensor based at least in part on the at least one irradiance metric.

9. The irradiance analysis computing device of claim 8, further configured to:
generate the irradiance estimate using an irradiance model.

10. The irradiance analysis computing device of claim 8, further configured to:
generate the irradiance estimate based on at least one of a location, a system orientation, a date, and a time.

11. The irradiance analysis computing device of claim 8, further configured to:
receive the first irradiance value from an irradiance sensor in communication with the irradiance analysis computing device via wired or wireless networks.

12. The irradiance analysis computing device of claim 8, further configured to:
receive an irradiance reference value wherein the irradiance reference value is a proxy for a second irradiance value;
process the irradiance reference value, the irradiance estimate, and the first irradiance value to generate a second irradiance metric;
determine whether the at least one irradiance sensor is in a normal condition or an anomalous condition based at least in part on the second irradiance metric.

13. The irradiance analysis computing device of claim 8, further configured to:
normalize the received irradiance estimate and the first irradiance value.

14. The irradiance analysis computing device of claim 8, further configured to:
determine whether the at least one irradiance sensor is at least one of miscalibrated, misoriented, obstructed, soiled, and otherwise impaired.

15. Computer-readable storage media for calibrating irradiance sensors, the computer-readable storage media having computer-executable instructions embodied thereon, wherein, when executed by at least one processor, the computer-executable instructions cause the processor to:
receive an irradiance estimate representing an expected amount of irradiance;
receive a first irradiance value associated with at least one irradiance sensor;
process the irradiance estimate and the first irradiance value to generate at least one irradiance metric; and
determine a condition of the at least one irradiance sensor based at least in part on the at least one irradiance metric.

16. The computer-readable storage media in accordance with claim 15, wherein the computer-executable instructions cause the processor to:
generate the irradiance estimate based on an irradiance model and at least one of a location, a system orientation, a date, and a time.

17. The computer-readable storage media in accordance with claim 15, wherein the computer-executable instructions cause the processor to:
receive an irradiance reference value wherein the irradiance reference value is a proxy for a second irradiance value;
process the irradiance reference value, the irradiance estimate, and the first irradiance value to generate a second irradiance metric;
determine whether the at least one irradiance sensor is in a normal condition or an anomalous condition based at least in part on the second irradiance metric.

18. The computer-readable storage media in accordance with claim 15, wherein the computer-executable instructions cause the processor to:
identify a minimum threshold value for the at least one irradiance metric; and
ignore irradiance metrics falling below the predetermined threshold.

19. The computer-readable storage media in accordance with claim 15, wherein the computer-executable instructions cause the processor to:
determine a confidence value associated with the at least one irradiance metric.

20. The computer-readable storage media in accordance with claim 15, wherein the computer-executable instructions cause the processor to:
determine whether the at least one irradiance sensor is at least one of miscalibrated, misoriented, obstructed, soiled, and otherwise impaired.

21. An irradiance analysis system used to calibrate an irradiance sensor associated with a photovoltaic system (“PV system”), the irradiance analysis system comprising:
a PV system;
an irradiance sensor associated with said PV system configured to determine irradiance measurements of said PV system; and
an irradiance analysis computing device in networked communication with said irradiance sensor, said irradiance analysis computing device including a processor and a memory coupled to said processor, said processor configured to:
receive an irradiance estimate representing an expected amount of irradiance received by said PV system;
receive a first irradiance value from said irradiance sensor;
process the irradiance estimate and the first irradiance value to generate at least one irradiance metric; and
determine a condition of said irradiance sensor based at least in part on the at least one irradiance metric.

22. The irradiance analysis system of claim 21, wherein said irradiance analysis computing device is further configured to:
generate the irradiance estimate using an irradiance model.

23. The irradiance analysis system of claim 21, wherein said irradiance analysis computing device is further configured to:
generate the irradiance estimate based on at least one of a location, a system orientation, a date, and a time.

24. The irradiance analysis system of claim 21, wherein said irradiance analysis computing device is further configured to:
receive the first irradiance value from said irradiance sensor via a wired or a wireless network.

25. The irradiance analysis system of claim 21, wherein said irradiance analysis computing device is further configured to:
receive an irradiance reference value wherein the irradiance reference value is a proxy for a second irradiance value, wherein the proxy for the second irradiance value represents a direct current output associated with said PV system;
process the irradiance reference value, the irradiance estimate, and the first irradiance value to generate a second irradiance metric;
determine whether said irradiance sensor is in a normal condition or an anomalous condition based at least in part on the second irradiance metric.

26. The irradiance analysis system of claim 21, wherein said irradiance analysis computing device is further configured to:
normalize the received irradiance estimate and the first irradiance value.

27. The irradiance analysis system of claim 21, wherein said irradiance analysis computing device is further configured to:
determine whether the at least one irradiance sensor is at least one of miscalibrated, misoriented, obstructed, soiled, and otherwise impaired.
